(19) United States
(12) Patent Application Publication
(10) Pub. No.: US 2023/0037525 A1
(43) Pub. Date: Feb. 9, 2023

(54) BIODEGRADABLE RESIN COMPOSITION

(71) Applicant: Ube Material Industries, Ltd., Ube-shi, Yamaguchi (JP)

(72) Inventors: Tetsuo Takayama, Yonezawa-shi, Yamagata (JP); Toru Inagaki, Ube-shi, Yamaguchi (JP); Yuzo Kato, Ube-shi, Yamaguchi (JP)

(73) Assignee: Ube Material Industries, Ltd., Ube-shi, Yamaguchi (JP)

(21) Appl. No.: 17/913,676

(22) PCT Filed: Mar. 1, 2021
(86) PCT No.: PCT/JP2021/007756

§ 371 Date: Sep. 22, 2022

(30) Foreign Application Priority Data
Mar. 30, 2020 (JP) 2020-059408

(51) Int. Cl. C08K 7/08; C08G 63/16

(52) U.S. Cl. CPC C08K 7/08; C08G 63/16; C08K 2003/3063

(57) ABSTRACT

The biodegradable resin composition according to the present invention contains an aliphatic polyester biodegradable resin and fibrous basic magnesium sulfate.

### TECHNICAL FIELD

The present invention relates to a biodegradable resin composition.

### BACKGROUND ART

In recent years, marine pollution by discarded plastic has become a major global problem. Since plastics discarded in the sea maintains its shape for a prolonged period of time, it has been pointed out that the plastic has an influence on an ecosystem such as eating disorder of marine organisms. In addition, microplastics micronized by ultraviolet rays or the like affect the food chain by intake of marine organisms, and may eventually be harmful to the human body. With the global awareness of SDGs, there is a need for biodegradable plastics, particularly biodegradable plastics having marine degradability.

Biodegradable resin compositions with enhanced various properties while maintaining biodegradability have been proposed. For example, a resin composition is disclosed in which wollastonite as an inorganic filler is blended in an aliphatic polyester resin (polybutylene succinate-lactic acid copolymer) to improve rigidity, heat resistance, and impact resistance while maintaining biodegradability (see, for example, Patent Literature 1).

It has also been reported that mechanical properties (flexural modulus) of polybutylene succinate (PBS) were improved by blending flabellate basic magnesium sulfate in PBS (see, for example, Non Patent Literature 1).

### CITATION LIST

### Patent Literature

Patent Literature 1: JP 2007-99794 A

### Non Patent Literature

Non Patent Literature 1: Ind. Eng. Chem. Res. 2017, 56, 3516-3526

### SUMMARY OF INVENTION

### Technical Problem

An aliphatic polyester obtained by a polycondensation method from an aliphatic dicarboxylic acid and a glycol is known as a chemically synthesized biodegradable plastic. In particular, succinic acid biodegradable resins including polybutylene succinate (PBS) and polybutylene succinate-adipate (PBSA) are promising materials from the viewpoint of having marine degradability, but have low rigidity due to their softness and have limited applications. There is a demand for a biodegradable resin composition that has more excellent marine degradability than a conventional one and gives a molded body having a high flexural modulus.

Therefore, an object of the present invention is to provide a biodegradable resin composition that has excellent marine degradability and gives a molded body having a high flexural modulus.

### Solution to Problem

The biodegradable resin composition according to the present invention contains an aliphatic polyester biodegradable resin and fibrous basic magnesium sulfate.

### Advantageous Effects of Invention

According to the present invention, it is possible to provide a biodegradable resin composition that has excellent marine degradability and gives a molded body having a high flexural modulus.

### DESCRIPTION OF EMBODIMENTS

The present inventors have made intensive studies and have thereby found that, in a resin composition obtained by blending fibrous basic magnesium sulfate in a biodegradable resin including an aliphatic polyester obtained from an aliphatic dicarboxylic acid and a glycol by a polycondensation method, the degradation in seawater is promoted, and a molded body having a high flexural modulus is obtained by using such a resin composition, thus completing the present invention.

Hereinafter, embodiments of the present invention will be described in detail.

<Fibrous Basic Magnesium Sulfate>

Fibrous basic magnesium sulfate is represented by MgSO₄.5Mg(OH)₂.3H₂O, and can be obtained by, for example, hydrothermal synthesis using magnesium sulfate and an alkaline substance such as sodium hydroxide, magnesium hydroxide, magnesium oxide, or calcium hydroxide as raw materials.

Fibers of fibrous basic magnesium sulfate have an average fiber length in the range of generally 2 to 100 μm and preferably 5 to 50 μm, and an average fiber diameter in the range of generally 0.1 to 2.0 μm and preferably 0.1 to 1.0 μm. The fibers of fibrous basic magnesium sulfate have an average aspect ratio (average fiber length/average fiber diameter) of generally 2 or more, preferably 3 to 1000, more preferably 3 to 100, and particularly preferably 5 to 50. Note that, the average fiber length and the average fiber diameter of fibers of fibrous basic magnesium sulfate can be calculated from the number average values of the fiber length and the fiber diameter respectively, which are measured by image analysis from images magnified with a scanning electron microscope (SEM).

The amount of fibrous basic magnesium sulfate to be contained is preferably 1 to 70%, and more preferably 1 to 50% when the total mass of an aliphatic polyester biodegradable resin and the fibrous basic magnesium sulfate is 100.

Wollastonite and the like are known as an inorganic filler that is blended in a biodegradable resin for improving physical properties. Because wollastonite does not dissolve in seawater, it is released into the ocean as a degradation residue of the biodegradable resin. In this case, an unexpected problem may occur due to accumulation of the released wollastonite.

On the other hand, fibrous basic magnesium sulfate degrades in seawater and generates no residue, so that such a problem can be avoided. Fibrous basic magnesium sulfate degrades into magnesium sulfate (MgSO₄) and magnesium hydroxide (Mg(OH)₂) in seawater. It is presumed that magnesium sulfate is dissolved in seawater, and magnesium hydroxide reacts with an acidic component present in the atmosphere to be dissolved as a Mg salt.

<Biodegradable Resin>

Examples of the biodegradable resin of the present invention include an aliphatic polyester biodegradable resin, which is a polycondensate of an aliphatic dicarboxylic acid and a glycol. Examples of the aliphatic dicarboxylic acid include succinic acid and adipic acid, and an aliphatic polyester biodegradable resin synthesized by a method of polycondensation of these aliphatic dicarboxylic acids and a glycol can be suitably used.

Examples of the succinic acid biodegradable resin include polybutylene succinate (PBS), polybutylene succinate-adipate (PBSA), and polybutylene succinate-lactate (PBSL). Further, examples thereof include polybutylene succinate-hydrocaproate (PBSLC), polybutylene succinate-carbonate (PBSC), polybutylene succinate-terephthalate (PBST), polybutylene succinate-diethylene glycol succinate (PBS-co-DEGS), polybutylene succinate-butylene (PBS-co-BDGA), and polybutylene succinate-fluonate (PBS F).

Examples of the adipic acid biodegradable resin include polybutylene adipate (PBA), polybutylene adipate-terephthalate (PBAT), and polyethylene adipate-terephthalate (PEAT).

These biodegradable resins may be used singly or in combination of two or more thereof. Among the biodegradable resins described above, PBSA and PBS are preferable from the viewpoint of marine degradability, resin physical properties, and the like.

<Method for Producing Biodegradable Resin Composition>

In production of the biodegradable resin composition of the present invention, first, a biodegradable resin and fibrous basic magnesium sulfate are mixed. For the mixing, a tumbler, a blender, a Henschel mixer, or the like can be used.

The obtained mixture is melt-kneaded at 160 to 210° C. using a twin-screw kneader or the like, and thus, the biodegradable resin composition of the present invention is obtained. The biodegradable resin composition of the invention is blended with fibrous basic magnesium sulfate, thereby having higher marine degradability than a conventional one. Moreover, it is possible to produce a molded body having a high flexural modulus by using the biodegradable resin composition of the invention.

The biodegradable resin composition of the present invention may contain other components as long as the effects of the invention are not impaired.

<Molded Body>

The biodegradable resin composition of the present invention is molded, whereby various molded bodies can be produced. For molding the resin composition, for example, a roll molding machine (such as a calender molding machine), a vacuum molding machine, an extrusion molding machine, an injection molding machine, a blow molding machine, or a press molding machine can be used.

By changing the amount of fibrous basic magnesium sulfate to be contained in the biodegradable resin composition, biodegradable resin compositions from soft to hard can be obtained.

The molded body of the present invention is suitably used in a wide range of applications such as packaging materials for packaging a liquid, granular, or solid product of various foods, chemicals, and miscellaneous goods; agricultural materials; and building materials. Specific examples thereof include injection molded articles (e.g., fresh food trays, coffee capsules, fast food containers, outdoor leisure products, and the like), extrusion molded articles (film, e.g., fishing line, fishing net, vegetation net, water retention sheet, and the like), and hollow molded articles (bottles and the like).

Further, other examples thereof include agricultural films, coating materials, coating materials for fertilizers, laminate films, plates, stretched sheets, monofilaments, nonwoven fabrics, flat yarns, staples, crimped fibers, scored tapes, split yarns, composite fibers, blow bottles, shopping bags, waste bags, compost bags, cosmetic containers, detergent containers, bleaching agent containers, ropes, binding materials, sanitary cover stock materials, cold insulation boxes, cushion material films, multifilaments, synthetic paper; and for medical use, surgical threads, sutures, artificial bones, artificial skins, drug delivery systems (DDS) such as microcapsules, and wound covering materials.

Furthermore, the molded body of the present invention can be used for information electronic materials such as toner binders and thermal transfer ink binders; and automobile parts including automobile interior parts such as electric product housings, instrument panels, sheets, and pillars, and automobile exterior structural materials such as bumpers, front grilles, and wheel covers. Examples that are more preferable among the above are packaging materials including packaging films, bags, trays, capsules, bottles, cushioning foams, and fish boxes; and agricultural materials. Examples of the agricultural materials include a mulching film, a tunnel film, a house film, a sunscreen, a grass protection sheet, a ridge sheet, a germination sheet, a vegetation mat, a seedling growing bed, and a pot.

As described above, the biodegradable resin composition of the present invention has excellent marine degradability, and the flexural modulus can be adjusted by the amount of fibrous basic magnesium sulfate to be contained, so that molded bodies for various applications can be obtained.

### EXAMPLES

Specific examples of the present invention will be described below, but these do not limit the invention.

The raw materials used are summarized below.

<Fibrous Basic Magnesium Sulfate>

A: MOS-HIGE A-1, manufactured by Ube Material Industries, Ltd., an average major diameter of 15 μm, an average minor diameter of 0.5 μm

<Succinic Acid Degradable Resin>

B-1: polybutylene succinate (BioPBS FZ71PM, manufactured by PTT MCC Biochem Co., Ltd.)

B-2: polybutylene succinate-adipate (BioPBS FD92PM, manufactured by PTT MCC Biochem Co., Ltd.)

<Inorganic Filler>

C: wollastonite

### Example 1

Fibrous basic magnesium sulfate (A) (1 part by mass) and polybutylene succinate (B-1) (99 parts by mass) were mixed. The obtained mixture was melt-kneaded at 160° C. using a twin-screw melt-kneading extruder (L/D=25, manufactured by Imoto machinery Co., Ltd.) to obtain a resin composition of Example 1.

### Example 2

A resin composition of Example 2 was obtained in the same manner as in Example 1 except that the amount of fibrous basic magnesium sulfate (A) was changed to 5 parts by mass and the amount of polybutylene succinate (B-1) was changed to 95 parts by mass.

### Example 3

A resin composition of Example 3 was obtained in the same manner as in Example 1 except that the amount of fibrous basic magnesium sulfate (A) was changed to 10 parts by mass and the amount of polybutylene succinate (B-1) was changed to 90 parts by mass.

### Example 4

Fibrous basic magnesium sulfate (A) (5 parts by mass) and polybutylene succinate-adipate (B-2) (95 parts by mass) were mixed. The obtained mixture was melt-kneaded at 160° C. using a twin-screw melt-kneading extruder (L/D=25, manufactured by Imoto machinery Co., Ltd.) to obtain a resin composition of Example 4.

### Example 5

A resin composition of Example 5 was obtained in the same manner as in Example 4 except that the amount of fibrous basic magnesium sulfate (A) was changed to 10 parts by mass and the amount of polybutylene succinate-adipate (B-2) was changed to 90 parts by mass.

### Example 6

A resin composition of Example 6 was obtained in the same manner as in Example 4 except that the amount of fibrous basic magnesium sulfate (A) was changed to 30 parts by mass and the amount of polybutylene succinate-adipate (B-2) was changed to 70 parts by mass.

### Example 7

A resin composition of Example 7 was obtained in the same manner as in Example 4 except that the amount of fibrous basic magnesium sulfate (A) was changed to 50 parts by mass and the amount of polybutylene succinate-adipate (B-2) was changed to 50 parts by mass.

### Comparative Example 1

Fibrous basic magnesium sulfate (A) was not blended, and polybutylene succinate (B-1) was used singly for Comparative Example 1.

### Comparative Example 2

Fibrous basic magnesium sulfate (A) was not blended, and polybutylene succinate-adipate (B-2) was used singly for Comparative Example 2.

### Comparative Example 3

A resin composition of Comparative Example 3 was obtained in the same manner as in Example 3 except that fibrous basic magnesium sulfate (A) was changed to the same amount of wollastonite (C).

### Comparative Example 4

A resin composition of Comparative Example 4 was obtained in the same manner as in Example 6 except that fibrous basic magnesium sulfate (A) was changed to the same amount of wollastonite (C).

The following Table 1 summarizes formulations of resin compositions of Examples and Comparative Examples.

TABLE 1

| | A | B (parts by mass) | | C |
|---|---|---|---|---|
| | (parts by mass) | B-1 | B-2 | (parts by mass) |
| Example 1 | 1 | 99 | | |
| Example 2 | 5 | 95 | | |
| Example 3 | 10 | 90 | | |
| Example 4 | 5 | | 95 | |
| Example 5 | 10 | | 90 | |
| Example 6 | 30 | | 70 | |
| Example 7 | 50 | | 50 | |
| Comparative | | 100 | | |
| Example 1 | | | | |
| Comparative | | | 100 | |
| Example 2 | | | | |
| Comparative | | 90 | | 10 |
| Example 3 | | | | |
| Comparative | | | 70 | 30 |
| Example 4 | | | | |

<Preparation of Test Piece>

Each resin composition was molded using a small injection molding machine (C, Mobile0813, manufactured by Shinko Celvic Co., Ltd.) to obtain a strip test piece (length: 50 mm, width: 5 mm, thickness: 2 mm) for evaluating mechanical characteristics.

<Evaluation of Flexural Modulus>

A three-point bending test was performed by a method in accordance with JISK7171 using a universal mechanical tester (manufactured by IMADA CO., LTD.). The distance between support points was 40 mm, and the loading rate was 10 mm/min. The flexural modulus was evaluated from an obtained load-deflection curve.

<Marine Degradability Test>

A molded body obtained in Example 6 or Comparative Example 2 was pulverized by freeze-pulverization to prepare a powder sample. The powder sample (76 mg of Example 6 or 53 mg of Comparative Example 2) and 200 mL of natural seawater (collected in Fukuoka City, Fukuoka Prefecture) were placed in a sealed container and stirred in a thermostatic bath at 30° C. The total oxygen consumption (TOD) of the test sample was 95.4 mgO₂. The oxygen consumption (BOD: biochemical oxygen demand) after 30 days was measured and the biodegradation degree (%) was calculated by ((BOD)/(TOD)×100).

The following Table 2 shows the flexural modulus of molded bodies employing respective resin compositions.

TABLE 2

| | Flexural modulus | Degree of |
|---|---|---|
| | (GPa) | biodegradation (%) |
| Example 1 | 0.7 | |
| Example 2 | 0.9 | |
| Example 3 | 1.2 | |
| Example 4 | 0.3 | |
| Example 5 | 0.6 | |
| Example 6 | 1.5 | 43 |
| Example 7 | 3.2 | |
| Comparative | 0.6 | |
| Example 1 | | |
| Comparative | 0.2 | 9 |
| Example 2 | | |
| Comparative | 1.0 | |
| Example 3 | | |
| Comparative | 0.8 | |
| Example 4 | | |

Comparison between Examples 1 to 3 and Comparative Example 1 shows that blending the fibrous basic magnesium sulfate in the polybutylene succinate improves the flexural modulus. The flexural modulus is higher as the amount of the blended fibrous basic magnesium sulfate is larger. Similar results are shown when the polybutylene succinate-adipate is used (Examples 4 to 7 and Comparative Example 2).

In addition, blending the fibrous basic magnesium sulfate significantly improves the marine degradability.

As shown in Comparative Examples 3 and 4, when the inorganic filler such as wollastonite is blended, the flexural modulus can also be increased as compared with that when no wollastonite is blended (Comparative Examples 1 and 2). However, wollastonite has a poor degree of biodegradation and does not degrade in the sea.

1. A biodegradable resin composition comprising an aliphatic polyester biodegradable resin and fibrous basic magnesium sulfate.

2. The biodegradable resin composition according to claim 1, wherein the fibrous basic magnesium sulfate is contained in an amount of 1 to 70% when a total mass of the aliphatic polyester biodegradable resin and the fibrous basic magnesium sulfate is 100.

3. The biodegradable resin composition according to claim 1, wherein the fibrous basic magnesium sulfate has an average fiber length in a range of 2 to 100 μm and an average fiber diameter in a range of 0.1 to 2.0 μm.

4. The biodegradable resin composition according to claim 1, wherein the aliphatic polyester biodegradable resin is a polycondensate of an aliphatic dicarboxylic acid and a glycol.

5. The biodegradable resin composition according to claim 4, wherein the aliphatic dicarboxylic acid is succinic acid or adipic acid.

6. The biodegradable resin composition according to claim 1, wherein the aliphatic polyester biodegradable resin is selected from polybutylene succinate and polybutylene succinate-adipate.

7. A molded body comprising the biodegradable resin composition according to claim 1.
